(19) United States
(12) Patent Application Publication
(10) Pub. No.: US 2022/0374943 A1
(43) Pub. Date: Nov. 24, 2022

(54) SYSTEM AND METHOD USING ATTENTION LAYERS TO ENHANCE REAL TIME BIDDING ENGINE

(71) Applicant: Zeta Global Corp., New York, NY (US)

(72) Inventors: Shubhranshu Barnwal, San Francisco, CA (US); Danny Portman, Johns Creek, GA (US); Zachary Jones, Decatur, GA (US)

(21) Appl. No.: 17/735,116

(22) Filed: May 3, 2022

Related U.S. Application Data
(60) Provisional application No. 63/182,745, filed on Apr. 30, 2021.

(51) Int. Cl. G06Q 30/02; G06N 3/08

(52) U.S. Cl. CPC G06Q 30/0275; G06Q 30/0246; G06N 3/08

(57) ABSTRACT

The subject technology identifies a series of journey event types in an online user journey, the event types including an impression event, an email event, a click event, and a website visit, and assigns an encoder to each event type. Using an assigned encoder, the technology encodes each event type to generate an encoded vector for each event type. The encoded vector is representative of at least a portion of the online user journey relating to that event type. The technology generates an encoded vector for each event type to create a set of encoded vectors, the set of encoded vectors including one or more of an impression event encoded vector, an email event encoded vector, a click event encoded vector, and a website visit encoded vector. The technology aggregates the set of encoded vectors to generate an output of the online user journey encoder, the output including a composite encoded user journey vector for training one or more attention layers to make a prediction.

### CLAIM OF PRIORITY

This patent application claims the benefit of priority, under 35 U.S.C. Section 919(e), to Barnwal et al, U.S. Provisional Patent Application Ser. No. 63/182,745, entitled “SYSTEM AND METHOD USING ATTENTION LAYERS TO ENHANCE REAL TIME BIDDING,” filed on Apr. 30, 2021 (Attorney Docket No. 4525.169PRV), which is hereby incorporated by reference herein in its entirety.

### TECHNICAL FIELD

The subject matter disclosed herein generally relates to the technical field of machine learning models utilized in a network-based computing environment. Improved programmatic ad buying technology that leverages machine learning models to determine bid amounts is provided.

### BACKGROUND

The present subject matter seeks to address technical problems existing in predicting online user activity, such as visits, actions, and transactions, and in determining bid amounts in advertising inventory auctions based on that activity.

### BRIEF DESCRIPTION OF THE DRAWINGS

Some embodiments are illustrated by way of example and not limitation in the figures of the accompanying drawings.

FIG. 1 is a block diagram illustrating a high-level network architecture, according to an example embodiment.

FIG. 2 is a block diagram showing architectural aspects of a publication system, according to some example embodiments.

FIG. 3 is a block diagram illustrating a representative software architecture, which may be used in conjunction with various hardware architectures herein described.

FIG. 4 is a block diagram illustrating components of a machine, according to some example embodiments, able to read instructions from a machine-readable medium (e.g., a machine-readable storage medium) and perform any one or more of the methodologies discussed herein.

FIG. 5 depicts aspects of an integrated user journey prediction and recommendation component, according to an example embodiment.

FIG. 6 depicts aspects of an impression event encoder, according to an example embodiment.

FIG. 7 depicts aspects of a user journey encoder, according to an example embodiment.

FIG. 8 depicts aspects of a learning module, according to an example embodiment.

FIG. 9 illustrates an example model architecture, according to an example embodiment.

FIG. 10 illustrates an example model architecture, according to an example embodiment.

FIG. 11 is a flow chart depicting operations in a method, according to an example embodiment.

### DETAILED DESCRIPTION

The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

In programmatic advertising, a user's past behavior can be used to determine characteristics of that user, such as his/her likes and dislikes. Machine learning algorithms can learn each user's preferences, then predict the intent of users to take certain actions.

The traditional/current approach is to generate an n-dimensional feature vector for each user. These features are typically static features which are unable to extract the sequential and ordered context from a user's activity.

There are several existing techniques for modeling time-series data such as a user's history. These techniques are theoretically capable of exploiting the sequential or ordered information present in online activity. However, many empirical results indicate that such models are extremely difficult and costly to train. Even when successfully trained, these models commonly suffer from debilitating limitations; they are limited to a short lookback period, and they lack explainability—the capacity to show which historical events resulted in a particular action.

The present invention uses attention layers to understand the correlations between a customer's previous actions and their likelihood to click or convert. Models are trained on historical user activity data and bid response data. The real-time bidding algorithms use the deep learning results to effectively target consumers with previous actions that indicate they are most likely to convert.

A networked system as described herein can predict online user activity and make recommendations to influence that activity and affect a consumer path or online journey, for example. Characterizing the behavior of consumers is difficult to accomplish. Known methods involve combining information about the user that is self-reported, provided by a third-party, or imputed, along with purchase behavior, click behavior, and general information about the websites visited by the user. While this information can provide insights, it is limited. In some examples, user journeys can be predicted and companies and marketers, for example, can better guide consumers towards a more desirable path to close a transaction (or convert, for example.

Some present examples track and seek to predict and/or influence online user activity. Some examples track a user's online interactions with advertisements. In one example non-limiting use case, advertisements may be tailored by a client of a marketing agency, or the agency itself. As explained more fully below, in some examples a user's interactions are encoded and represented as a series of time-stamped events, such as display/mobile advertisements, clicks, website visits, opened emails, conversions, and the like. Having established an historic record of user journeys, some examples predict next steps for a given user and assign a probability to each predicted next step or action, either singly as one action or as an expected combination of events or actions in a journey. An example system can predict aspects such as churn, predict transactions (such as conversions), and determine optimal marketing strategies from creative content, channel of media, time of placement, and the like. An example system can predict consumer paths in real-time and adjust content presented to consumers in order to guide them down a more desired or beneficial paths.

Embodiments of the improved technology seek to address at least some of the aforementioned issues by providing and utilizing a machine learning model to predict online user activity and adapt, in an automated manner, the presentation of online content. Examples seek to determine more accurately online user activity based on the presentation of recommended content, in an influencing feedback loop, as it were. In some examples, systems and methods in accordance with the disclosure use machine learning to identify a user's potential online journey, predict what a user such as an end consumer is likely to do next, generate sequences of potential next steps for consumers that are likely to lead to a conversion event, and suggest what manner and type of content to present to a consumer to put that consumer on a path to a conversion event.

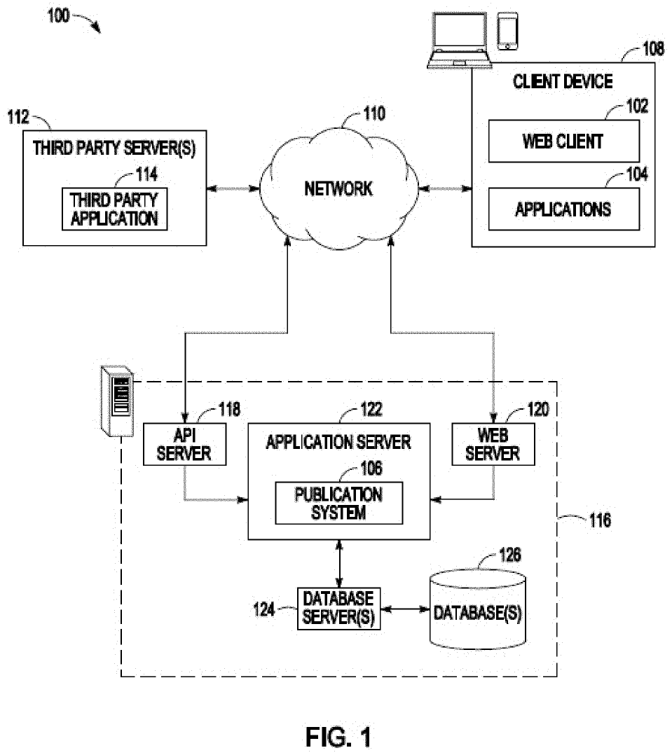

With reference to FIG. 1, an example embodiment of a high-level SaaS network architecture 100 is shown. A networked system 116 provides server-side functionality via a network 110 (e.g., the Internet or a WAN) to a client device 108. A web client 102 and a programmatic client, in the example form of a client application 104, are hosted and execute on the client device 108. The networked system 116 includes an application server 122, which in turn hosts a publication system 106 (such as a marketing agency, an advertising exchange, or a content distributor) that provides a number of functions and services to the client application 104 that accesses the networked system 116. The client application 104 also provides a number of interfaces described herein, which can present an output in accordance with the methods described herein to a user of the client device 108.

The client device 108 enables a user to access and interact with the networked system 116 and, ultimately, the publication system 106. For instance, the user provides input (e.g., touch screen input or alphanumeric input) to the client device 108, and the input is communicated to the networked system 116 via the network 110. In this instance, the networked system 116, in response to receiving the input from the user, communicates information back to the client device 108 via the network 110 to be presented to the user.

An API server 118 and a web server 120 are coupled, and provide programmatic and web interfaces respectively, to the application server 122. The application server 122 hosts the publication system 106, which includes components or applications described further below. The application server 122 is, in turn, shown to be coupled to a database server 124 that facilitates access to information storage repositories (e.g., a database 126). In an example embodiment, the database 126 includes storage devices that store information accessed and generated by the publication system 106.

Additionally, a third-party application 114, executing on one or more third-party servers 112, is shown as having programmatic access to the networked system 116 via the programmatic interface provided by the API server 118. For example, the third-party application 114, using information retrieved from the networked system 116, may support one or more features or functions on a website hosted by a third party.

Turning now specifically to the applications hosted by the client device 108, the web client 102 may access the various systems (e.g., the publication system 106) via the web interface supported by the web server 120. Similarly, the client application 104 (e.g., a marketing agency “app”) accesses the various services and functions provided by the publication system 106 via the programmatic interface provided by the API server 118. The client application 104 may be, for example, an “app” executing on the client device 108, such as an iOS or Android OS application to enable a user to access and input data on the networked system 116 in an offline manner and to perform batch-mode communications between the client application 104 and the networked system 116.

Further, while the SaaS network architecture 100 shown in FIG. 1 employs a client-server architecture, the present inventive subject matter is of course not limited to such an architecture, and could equally well find application in a distributed, or peer-to-peer, architecture system, for example. The publication system 106 could also be implemented as a standalone software program, which does not necessarily have networking capabilities.

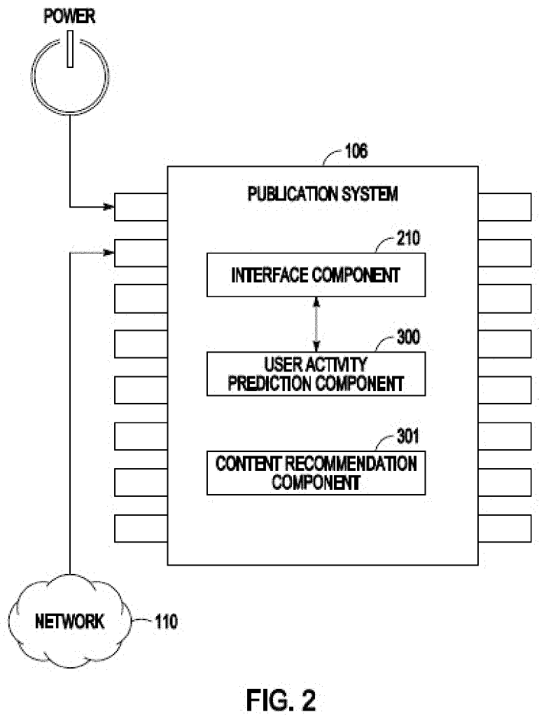

FIG. 2 is a block diagram showing architectural details of a publication system 106, according to some example embodiments. Specifically, the publication system 106 is shown to include an interface component 210 by which the publication system 106 communicates (e.g., over a network 110) with other systems within the SaaS network architecture 100.

The interface component 210 is communicatively coupled to a user activity prediction component 300 that operates to provide online user activity (e.g., consumer activity, actions, or transactions) prediction and processing functions. The interface component 210 and the user activity prediction component 300 are also communicatively coupled to a content recommendation component 301 for recommending and tailoring creative content and the presentation of content in accordance with the methods described further below with reference to the accompanying drawings.

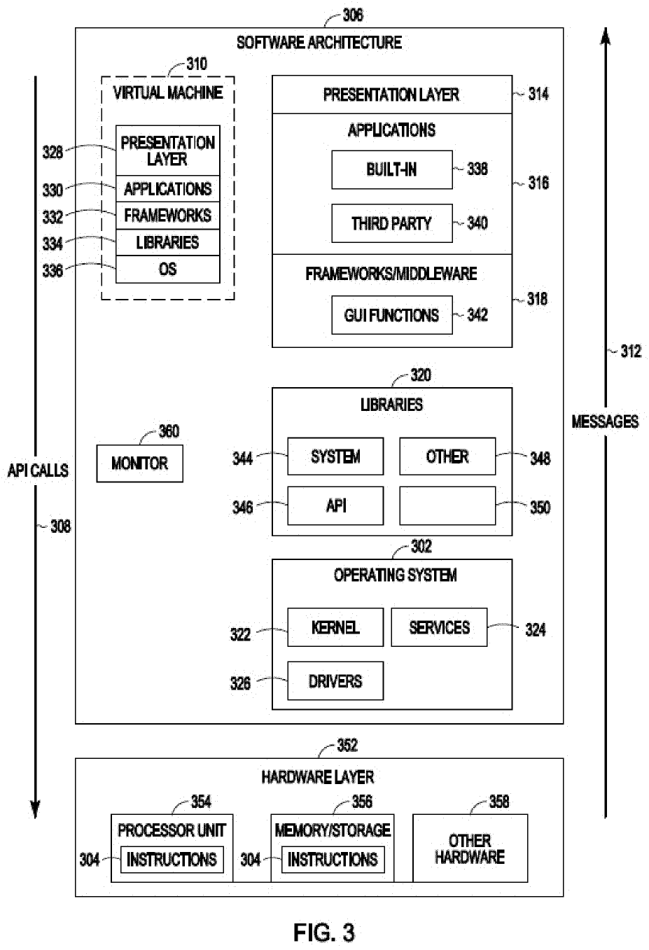

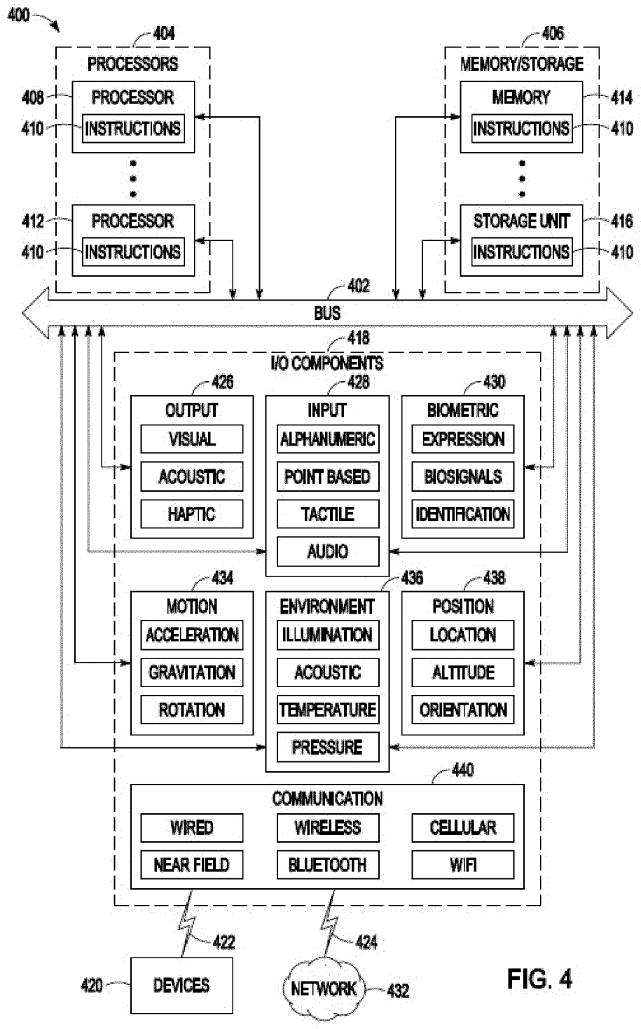

FIG. 3 is a block diagram illustrating an example software architecture 306, which may be used in conjunction with various hardware architectures herein described. FIG. 3 is a non-limiting example of a software architecture 306, and it will be appreciated that many other architectures may be implemented to facilitate the functionality described herein. The software architecture 306 may execute on hardware such as a machine 400 of FIG. 4 that includes, among other things, processors 404, memory/storage 406, and input/output (I/O) components 418. A representative hardware layer 352 is illustrated and can represent, for example, the machine 400 of FIG. 4. The representative hardware layer 352 includes a processor 354 having associated executable instructions 304. The executable instructions 304 represent the executable instructions of the software architecture 306, including implementation of the methods, components, and so forth described herein. The hardware layer 352 also includes memory and/or storage modules as memory/storage 356, which also have the executable instructions 304. The hardware layer 352 may also comprise other hardware 358.

In the example architecture of FIG. 3, the software architecture 306 may be conceptualized as a stack of layers where each layer provides particular functionality. For example, the software architecture 306 may include layers such as an operating system 302, libraries 320, frameworks/middleware 318, applications 316, and a presentation layer 314. Operationally, the applications 316 and/or other components within the layers may invoke API calls 308 through the software stack and receive a response as messages 312 in response to the API calls 308. The layers illustrated are representative in nature, and not all software architectures have all layers. For example, some mobile or special-purpose operating systems may not provide a frameworks/middleware 318, while others may provide such a layer. Other software architectures may include additional or different layers.

The operating system 302 may manage hardware resources and provide common services. The operating system 302 may include, for example, a kernel 322, services 324, and drivers 326. The kernel 322 may act as an abstraction layer between the hardware and the other software layers. For example, the kernel 322 may be responsible for memory management, processor management (e.g., scheduling), component management, networking, security settings, and so on. The services 324 may provide other common services for the other software layers. The drivers 326 are responsible for controlling or interfacing with the underlying hardware. For instance, the drivers 326 include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 320 provide a common infrastructure that is used by the applications 316 and/or other components and/or layers. The libraries 320 provide functionality that allows other software components to perform tasks in an easier fashion than by interfacing directly with the underlying operating system 302 functionality (e.g., kernel 322, services 324, and/or drivers 326). The libraries 320 may include system libraries 344 (e.g., C standard library) that may provide functions such as memory allocation functions, string manipulation functions, mathematical functions, and the like. In addition, the libraries 320 may include API libraries 346 such as media libraries (e.g., libraries to support presentation and manipulation of various media formats such as MPEG4, H.264, MP3, AAC, AMR, JPG, and PNG), graphics libraries (e.g., an OpenGL framework that may be used to render 2D and 3D graphic content on a display), database libraries (e.g., SQLite that may provide various relational database functions), web libraries (e.g., WebKit that may provide web browsing functionality), and the like. The libraries 320 may also include a wide variety of other libraries 348 to provide many other APIs to the applications 316 and other software components/modules.

The frameworks/middleware 318 provide a higher-level common infrastructure that may be used by the applications 316 and/or other software components/modules. For example, the frameworks/middleware 318 may provide various graphic user interface (GUI) functions 342, high-level resource management, high-level location services, and so forth. The frameworks/middleware 318 may provide a broad spectrum of other APIs that may be utilized by the applications 316 and/or other software components/modules, some of which may be specific to a particular operating system or platform.

The applications 316 include built-in applications 338 and/or third-party applications 340. Examples of representative built-in applications 338 may include, but are not limited to, a contacts application, a browser application, a book reader application, a location application, a media application, a messaging application, and/or a game application. The third-party applications 340 may include any application developed using the ANDROID™ or IOS™ software development kit (SDK) by an entity other than the vendor of the particular platform and may be mobile software running on a mobile operating system such as IOS™, ANDROID™, WINDOWS® Phone, or other mobile operating systems. The third-party applications 340 may invoke the API calls 308 provided by the mobile operating system (such as the operating system 302) to facilitate functionality described herein.

The applications 316 may use built-in operating system functions (e.g., kernel 322, services 324, and/or drivers 326), libraries 320, and frameworks/middleware 318 to create user interfaces to interact with users of the system. Alternatively, or additionally, in some systems, interactions with a user may occur through a presentation layer, such as the presentation layer 314. In these systems, the application/component “logic” can be separated from the aspects of the application/component that interact with a user.

Some software architectures use virtual machines. In the example of FIG. 3, this is illustrated by a virtual machine 310. The virtual machine 310 creates a software environment where applications/components can execute as if they were executing on a hardware machine (such as the machine 400 of FIG. 4, for example). The virtual machine 310 is hosted by a host operating system (e.g., the operating system 302 in FIG. 3) and typically, although not always, has a virtual machine monitor 360, which manages the operation of the virtual machine 310 as well as the interface with the host operating system (e.g., the operating system 302). A software architecture executes within the virtual machine 310 such as an operating system (OS) 336, libraries 334, frameworks 332, applications 330, and/or a presentation layer 328. These layers of software architecture executing within the virtual machine 310 can be the same as corresponding layers previously described or may be different.

FIG. 4 is a block diagram illustrating components of a machine 400, according to some example embodiments, able to read instructions from a non-transitory machine-readable medium (e.g., a non-transitory machine-readable storage medium) and perform any one or more of the methodologies discussed herein. Specifically, FIG. 4 shows a diagrammatic representation of the machine 400 in the example form of a computer system, within which instructions 410 (e.g., software, a program, an application, an applet, an app, or other executable code) for causing the machine 400 to perform any one or more of the methodologies discussed herein may be executed. As such, the instructions 410 may be used to implement modules or components described herein. The instructions 410 transform the general, non-programmed machine 400 into a particular machine 400 programmed to carry out the described and illustrated functions in the manner described. In alternative embodiments, the machine 400 operates as a standalone device or may be coupled (e.g., networked) to other machines. In a networked deployment, the machine 400 may operate in the capacity of a server machine or a client machine in a server-client network environment, or as a peer machine in a peer-to-peer (or distributed) network environment. The machine 400 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 410, sequentially or otherwise, that specify actions to be taken by the machine 400. Further, while only a single machine 400 is illustrated, the term “machine” shall also be taken to include a collection of machines that individually or jointly execute the instructions 410 to perform any one or more of the methodologies discussed herein.

The machine 400 may include processors 404 (including processors 408 and 412), memory/storage 406, and I/O components 418, which may be configured to communicate with each other such as via a bus 402. The memory/storage 406 may include a memory 414, such as a main memory, or other memory storage, and a storage unit 416, both accessible to the processors 404 such as via the bus 402. The storage unit 416 and memory 414 store the instructions 410 embodying any one or more of the methodologies or functions described herein. The instructions 410 may also reside, completely or partially, within the memory 414, within the storage unit 416, within at least one of the processors 404 (e.g., within the processor's cache memory), or any suitable combination thereof, during execution thereof by the machine 400. Accordingly, the memory 414, the storage unit 416, and the memory of the processors 404 are examples of machine-readable media.

The I/O components 418 may include a wide variety of components to receive input, provide output, produce output, transmit information, exchange information, capture measurements, and so on. The specific I/O components 418 that are included in a particular machine will depend on the type of machine. For example, portable machines such as mobile phones will likely include a touch input device or other such input mechanisms, while a headless server machine will likely not include such a touch input device. It will be appreciated that the I/O components 418 may include many other components that are not shown in FIG. 4. The I/O components 418 are grouped according to functionality merely for simplifying the following discussion, and the grouping is in no way limiting. In various example embodiments, the I/O components 418 may include output components 426 and input components 428. The output components 426 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 428 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and/or force of touches or touch gestures, or other tactile input components), audio input components (e.g., a microphone), and the like.

In further example embodiments, the I/O components 418 may include biometric components 430, motion components 434, environment components 436, or position components 438, among a wide array of other components. For example, the biometric components 430 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 434 may include acceleration sensor components (e.g., accelerometer), gravitation sensor components, rotation sensor components (e.g., gyroscope), and so forth. The environment components 436 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas sensors to detect concentrations of hazardous gases for safety or to measure pollutants in the atmosphere), or other components that may provide indications, measurements, or signals corresponding to a surrounding physical environment. The position components 438 may include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 418 may include communication components 440 operable to couple the machine 400 to a network 432 or devices 420 via a coupling 424 and a coupling 422, respectively. For example, the communication components 440 may include a network interface component or other suitable device to interface with the network 432. In further examples, the communication components 440 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 420 may be another machine or any of a wide variety of peripheral devices (e.g., a peripheral device coupled via a USB).

Moreover, the communication components 440 may detect identifiers or include components operable to detect identifiers. For example, the communication components 440 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 440, such as location via Internet Protocol (IP) geo-location, location via Wi-Fi® signal triangulation, location via detecting an NFC beacon signal that may indicate a particular location, and so forth.

Some examples provide a machine learning model to predict online user activity and improve conversion attribution (e.g., identifying the marketing channel that lead a user to perform a desired action online) in view of analyzed online user events from a given network(s). These examples improve the functionality of a computer (e.g., machine 400, software architecture, and the like), and increase the probability of a desired online user event and at the same time reduce utilization of computational resources (e.g., processor, memory, network, and the like).

Compared with previous machine learning approaches that predict an activity with lower accuracy or determine conversion attribution with lower confidence, the subject technology provides machine learning approaches that instead determine conversion attribution with improved confidence, identify and predict with improved accuracy a consumer's potential online journey, predict what an end consumer is likely to do next, generate sequences of potential next steps for users that are likely to lead to a conversion event, and suggest what to present to a consumer to put that consumer on a path to a conversion event. The present invention specifically tracks users' online interactions with advertisements. The users' interactions are represented at a series of time-stamped events, such as display/mobile advertisements, clicks, website visits, opened emails, conversions, and the like. The events are analyzed using a machine learning model including one or more network and attention layers to determine conversion attribution and prediction future user activities.

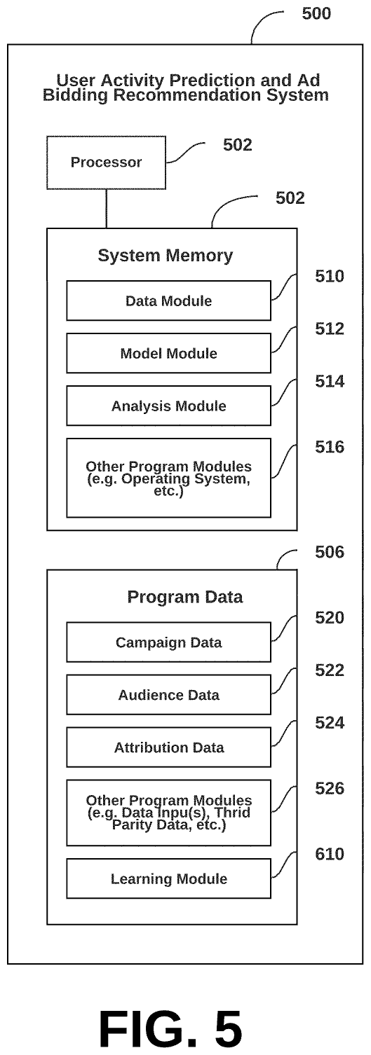

With reference to FIG. 5, in some examples the user activity prediction component 300 and the content recommendation component 301 are combined into an integrated user activity prediction and ad bidding recommendation component 500. In this exemplary implementation, the user activity prediction and ad bidding recommendation component 500 includes at least one processor 502 coupled to a system memory 504, as shown by the block diagram in FIG. 5. The system memory 504 may include computer program modules 506 and program data 508. In this implementation program modules 506 may include a data module 510, a model module 512, an analysis module 514, and other program modules 516 such as an operating system, device drivers, and so forth. Each module 510 through 516 may include a respective set of computer-program instructions executable by one or more processors 502.

This is one example of a set of program modules, and other numbers and arrangements of program modules are contemplated as a function of the particular arbitrary design and/or architecture of user activity prediction and ad bidding recommendation component 500. Additionally, although shown on a single user activity prediction and ad bidding recommendation component 500, the operations associated with respective computer-program instructions in the program modules 506 could be distributed across multiple computing devices. Program data 508 may include campaign data 520, audience data 522, attribution data 524, and other program data 526 such as data input(s), third-party data, and/or others. In some examples, user activity prediction and ad bidding recommendation component 500 includes a learning module 610, described further below.

In various embodiments, the user activity prediction and ad bidding recommendation component 500 collects information and transactions tied to user identifiers including third party cookies, single sign on, IP addresses, or any other means of identifying an individual end consumer and can detect patterns of transaction events. In some examples, desired transaction events may include a purchase (also called a conversion), a sign-up, a click-through for a particular client, or the like.

Various machine learning models generated by the learning module 610 may include one or more network layers. For example, the network layers may use long short-term memory (LSTM) to perform deep learning on sequences of transaction events. The LSTM can model the complex time-series data of the time-stamped user events mapped to each unique user id. In these ideal embodiments, (1) historical interactions as n-length numeric vectors are encoded, (2) each recorded journey is assembled into a time-series of encoded vectors, (3) the LSTM is trained on the transformed data/encoded vectors, and (4) the LSTM predicts next stages including how to bid on available inventory, creative to place in the inventory.

The machine learning models generated by the learning module 610 may also include one or more attention layers that re-enforce particular portions of the recorded journey to enable the model to incorporate re-enforced portions during its prediction process. The attention layers enable the event encoder to avoid the burden of having to encode all information in the source event into a fixed length vector. The attention layers spread the encoded information throughout a sequence of annotations, which can be selectively retrieved by the decoder when necessary.

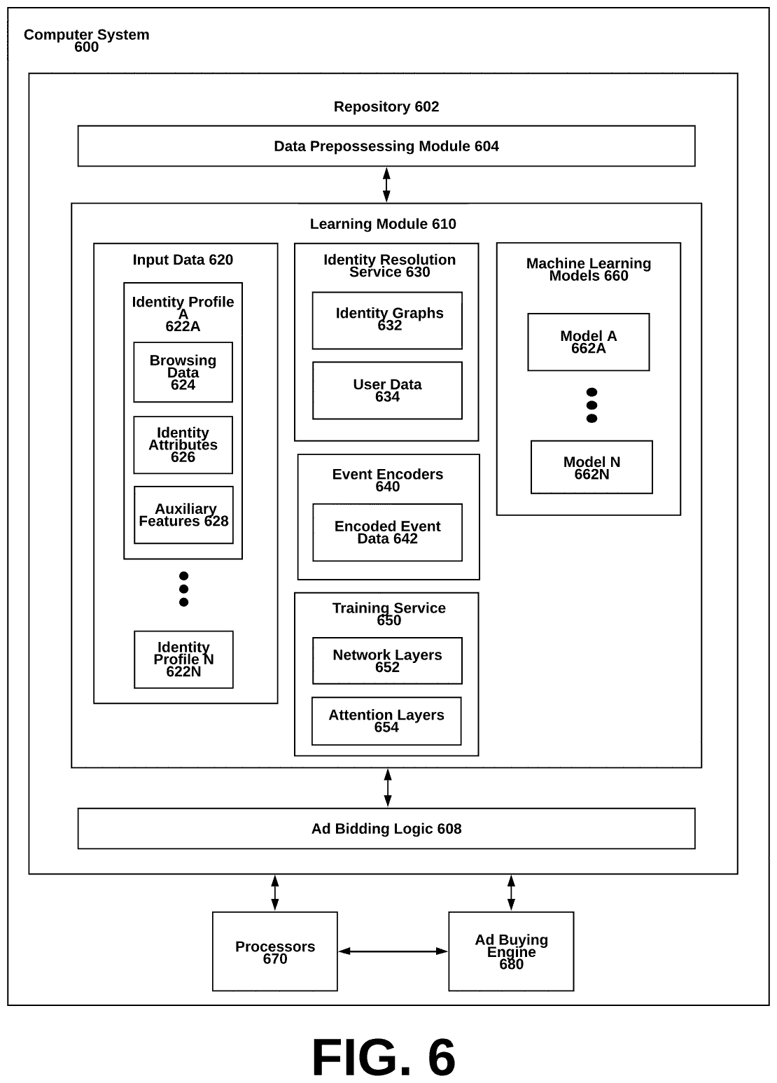

FIG. 6 is a block diagram illustrating more details of the learning module 610 in accordance with one or more embodiments of the disclosure. The learning module 610 may be implemented using a computer system 600. In various embodiments, the computer system 600 may include a repository 602, an ad buying engine 680, and one or more computer processors 670. In one or more embodiments, the computer system 600 takes the form of the application servicer 122 described above in FIG. 1 or takes the form of any other computer device including a processor and memory. In one or more embodiments, the computer processor(s) 670 takes the form of the processor 502 described in FIG. 5.

In one or more embodiments, the repository 602 may be any type of storage unit and/or device (e.g., a file system, database, collection of tables, or any other storage mechanism) for storing data. Further, the repository 602 may include multiple different storage units and/or devices. The multiple different storage units and/or devices may or may not be of the same type or located at the same physical site. The repository 602 may include a data preprocessing module 604, the learning module 610, and ad bidding logic 608.

The data preprocessing module 604 includes programing instructions for performing Extract, Transform, and Load (ETL) tasks. The ETL jobs process input data 620 collected from numerous data sources. For example, the ETL jobs extract raw data from different data sources and clean and normalize the raw data to convert it into a standardized data format that may be used efficiently by other components of the learning module 610. The data preprocessing module may also include one or more services that further process the raw data to derive additional insights and attributes about the raw data. To increase the speed and efficiency of the data preprocessing module, many of the ETL tasks can be parallel in nature. Accordingly, a failure of a task (say due to nonavailability of daily user activity, server going down, etc.) results in appropriate error logging and retries. In various embodiments, few of the ETL steps are compulsory (i.e., without which the further steps of the ETL pipeline do not run and few of the ETL jobs are optional (i.e., the pipeline proceeds further after failure of these steps after a predetermined number of retries.)

In various embodiments, the data preprocessing package 604 collects browsing data 624 from one or more cloud storage systems. The browsing data 624 may be generated by one or more applications that track online activity across millions of pixeled websites. The browsing data 624 may include browsing activity for millions of individual identities 622A, . . . , 622N. The browsing data 624 may include the URL of the website visited, the identifier (e.g., a cookie, a mobile id, a device id, or other identifier) for the identity 622A that visited the website, and one or more pieces of browsing metadata. For example, the browsing metadata may include the brand and make of the device visiting the website, its operating system, the browser used, location of the device either through global position system (GPS) data collected by the device and/or the location IP address used to visit the website, a precise time the identifier visited the URL, and the like). The browsing data may also include impression data that tracks user engagement with digital content. For example, the impression data may include impression events (e.g., displays, views, clicks, response and other user inputs, purchases and other transactions, and the like) performed by one or more users navigating a communications network (e.g., the Internet).

The browsing data may be captured in its raw form and stored in one or more server groups implementing a cloud storage system (e.g., AWS, Snowflake, GCP, Azure, or a proprietary cloud storage service). The data preprocessing module 604 may determine one or more insights from the raw browsing data. For example, the data preprocessing module 604 may include a classification service URL of the websites visited may be classified into topics, taxonomy labels, or other classes that provide insights into the type of content of the website associated with the URL. The data preprocessing module 604 may also include an ad tracking service that tracks impression events for advertisements and other targeted content displayed on the web page located at a particular URL. The ad tracking service may determine what advertisements were displayed to an identity 622A and the identity's 622A response to each advertisement (e.g., whether the identity 622A did nothing, clicked the advertisement, viewed the advertisement, made a purchase based on the advertisement, and the like). The URL classifications and impression data recorded for each identity 622A, . . . , 622N may be added to the browsing data 624 stored for each identity 622A, . . . , 622N.

To provide a more holistic view of the identities 622A, . . . , 622N, the browsing data 624 may be augmented with one or more identity attributes 626 and other auxiliary features 628. The identity attributes 626 may include demographic data points (e.g., gender, age group, and income levels of the tracked identity, number of family members in the identity's household, postal code of the household, recent purchases made by the identity, identity's affinity towards one or more brands, services and product categories, GPS coordinates/business locations the identity visited in recently times, and the like). The auxiliary features 628 include identity specific data points that may be aggregated by one or more third parties (e.g., business organizations, survey companies, clients (e.g., merchants or brands that are clients of an advertising service), and the like). For example, auxiliary features may include a number of children or members in the identity's household, important dates for the identity such as anniversary dates or birthdays, a list of a client's profitable customers, a list of a client's non-profitable customers, customers who recently responded to offers vs customers who did not respond to offer, and the like.

The auxiliary features may also include one or more intender attributes derived from browsing data 624 and/or identity attributes 626. The intender attributes may include individual metrics that may be used to determine an intent of a consumer to purchase a product, visit a store, view an ad, or perform another action. For example, the intender attributes may include individual level brand propensities (e.g., a tendency of the consumer to shop at store of a particular brand, purchase a particular brand of athletic shoes or other goods, consume content on YouTube or another particular media publisher by a particular band, and the like), brand affinity scores (e.g., metrics that describe how frequency and/or consistently consumers engage with particular brands, for example, how often consumers purchase products made by the brand, click or view ad or emails send by the brand, visit particular brand website, and the like), product propensities (e.g., the types of products or services consumers frequently and/or consistently buy or show interest in), and the like. The intender attributes may also include semantic codes (e.g., key words or important terms) summarizing the content of web pages and other digital media browsed by consumers. The intender attributes may also include an attitude or behavioral propensity (e.g., materialistic, athletic, health conscious, frugal, aggressive, or other personality trait) or a channel propensity (e.g., email, web page display, mobile ad, connected tv media, or other marketing channel preferred by a consumer).

The browsing data 624, identity attributes 626, and auxiliary features 628 for each of the identities 622A, . . . , 622N may be processed by the identity resolution service to connect the identities with individual users. For example, the data for each of the identities 622A, . . . , 622N may be stored in one or more identity graphs 632. Each identity 622A, . . . , 622N included in the input data 620 may be associated with a unique identifier (e.g., device address, email address, cookie id, mobile device id, IP address, and the like). The identity resolution service may generate the identity graphs 632 by connecting the identities 622A, . . . , 622N with individual users based on known identifiers that are associated with each of the individual users. For example, an individual user may be known by the identity resolution service 630 to be associated with three different email address and two different mobile device ids. Accordingly, the identity graphs generated by the identity resolution service 630 will connect the identities for the five different identifiers to the same user. The identity resolution service 630 may parse the identity graphs 632 in order to generate user data 634 that includes one or more user profiles. Each user profile may include all of the data in each identity associated with a particular user. Accordingly, the identity resolution service 630 may rapidly and efficiently assemble holistic user profiles for target audiences and other groups of users that are of interest to a particular client. The impression event encoders 640 and training service 650 may generate client, audience, opportunity, product, and other customizable use specific machine learning models based on the user data 634.

The event encoders 640 may compute one or more machine learning model features based on the user data 634. For example, the event encoders may compute a feature for every impression event (e.g., webpage hit, ad view, opened email, click, conversion, and the like) included in a user's browsing data 624. The feature may encode the event and other pieces of data (e.g., browsing data 624, identity attributes 626, and auxiliary features 628) included in one or more identities for the user into a numeric vector. The numeric vectors are stored as encoded event data 636. In various embodiments, the event encoders 640 may include different types of encoders for the various types of user activities included in browsing data 624. For example, there may be an impression event encoder, an email encoder, a click encoder, a website encoder, and the like. Each or some events recorded in a user's browsing data 624 may be encoded through a respective encoder.

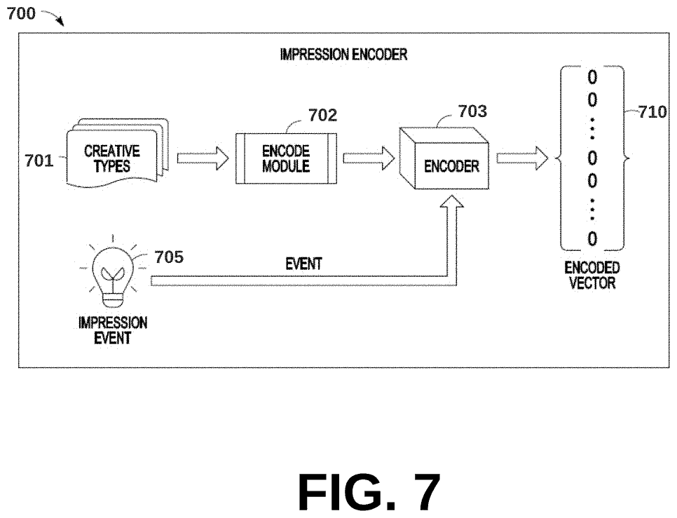

FIG. 7 illustrates more details for an embodiment of an impression event encoder 700. To translate impression events included in browsing data 624 to numeric vectors. Creative content types 701 (for example, articles, or advertisements) are parsed through an encode module 702. Output from the encode module 702 is passed to an encoder 703 in relation to a desired impression event 705. The encoder 703 outputs an encoded vector 710. While an impression event encoder 700 is depicted in this example as specific to impression events, in some examples one encoder or any number of encoders may be used for various other types of events in a user's online journey.

By way of example, a user associated with identity A 622A having an identification number (id) of, say, 123456789 may have browsing data 624 including the following events: on 1/1/21 5:30 pm, the user opened a marketing email advertising product XYZ; on 1/2/21 10:30 am, the user is shown a display advertisement using creative A; on 1/2/21 2:00 μm, the user is shown a display advertisement using creative B; on 1/2/21 2:01 pm, the user clicks advertisement with creative B and visits the advertiser's site; on 1/3/21 7 pm, the user visits the advertiser's website. The series of events is collectively classified as the user number 123456789's journey. The encoded vector 710 of user 123456789's multiple impressions is tracked and encoded by the components of the impression event encoder 700.

In some examples, an output vector 710 for each encoder is padded and then re-sequenced into the correct order, for example re-sequenced into a time-based or type order. In some examples, a padding operation adds layers of zeros to input images to prevent shrinking. For example, if p=number of layers of zeros added to the border of the image, then an (n×n) image becomes (n+2p)×(n+2p) image after padding. In some examples, padding extends an area of an image in which a convolutional neural network processes. A kernel/filter (e.g., the kernel 322 of FIG. 3) which moves across the image scans each pixel and converts the image into a smaller image. Adding padding to an image processed by a convolutional neural network allows for a more accurate analysis of images.

To generate a prediction (e.g., a conversion attribution probability, a user event prediction, and the like), the encoded event data 642 is fed into one of the machine learning models 660 generated by the training service 650. The training service 650 may assemble the machine learning models 660 by combining one or more trained network layers 652 with one or more attention layers 654. The network layers 652 may include Recurrent Neural Network (RNN) units, Long Short-Term Memory (LSTM) units, Gated Recurrent units (GRU), and other neural network implementations. The network layers 652 generate an output vector that is fed into a softmax or other classification layer that generates a prediction based on the combined output vectors from each of the network layers 652. The output vector generated by the network layers 652 may also be fed into one or more attention layers 654 that may modify the output vector from the network layers 652 based on one or more attention weights in order to embed additional information into the output vectors. The output vector from the attention layers is then fed into a classification layer to generate a prediction. The attention layers 654 may increase the accuracy or confidence of the prediction generated by the machine learning model.

To help the machine learning models consider more information, The attention layers 654 may generate a context vector that captures relevant source-side information (e.g., user data embedded in the output vector generated from by the network layers) to help make a prediction. The context vector may be generated by combining outputs from multiple network layers based on the attention weights. In various embodiments, the attention layers 654 may derive the context vector using a global or local attention mechanism. Global attention mechanisms may consider all of the hidden states of the encoder (i.e., the output of all of the network layers) when deriving a context vector. The global attention mechanism implemented in the attention layers 654 may include dot product attention mechanism, Bandanau attention mechanism, Luong attention mechanism, or other global attention mechanism known in the art. Local attention mechanisms consider only a small subset of the hidden states of the encoder and therefore are more efficient to operate, easier to train, and support longer source vectors. Relative to global attention mechanisms, local attention mechanisms involve an additional step of predicting an alignment vector that is used to select the hidden states to use consider for local attention. The local attention mechanism implemented in the attention layers 654 may use monotonic alignment, predictive alignment, and the like to determine the alignment vector.

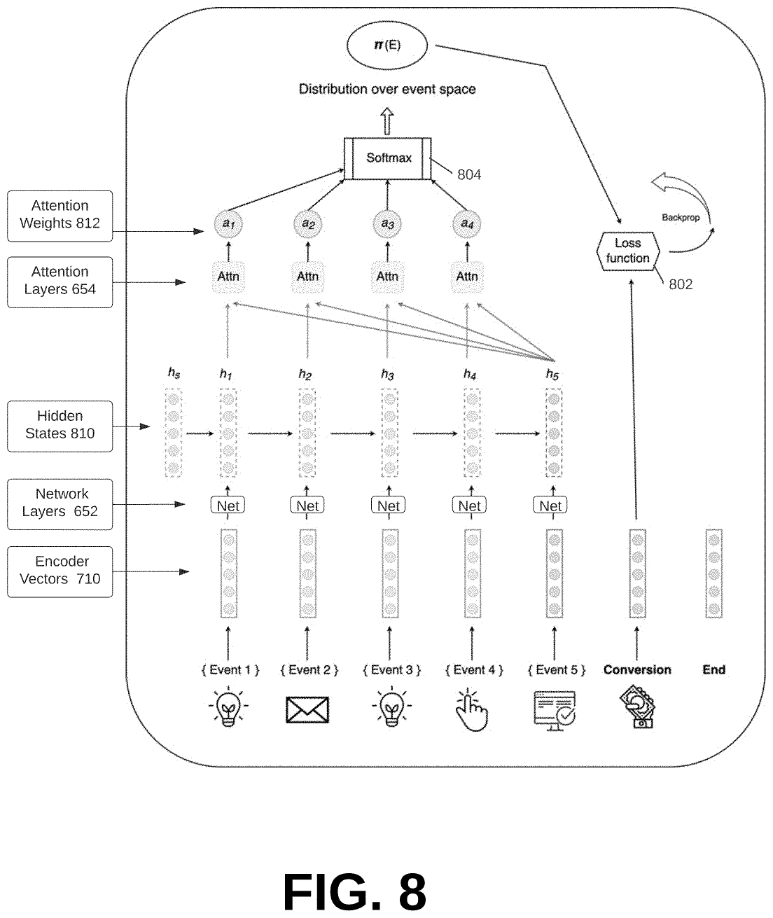

FIG. 8 illustrates an example machine learning model that includes both network layers 652 and attention layers 654. The machine learning model may include one or more multiple LSTM unites arranged in an encoder-decoder architecture. The network layers 652 may be encoder layers that receive the encoder vectors 710 as input and generate hidden states as output. The hidden states may be a lower dimension representation of the encoder vectors that includes only the most important information included in the encoder vectors. The network layers 652 may determine the hidden states 810 based on a set of trained weights that are determined during a training process.

The vector representations included in the hidden states 810 for one or more impression events may be fed into each of the attention layers 654. For example, the attention units may receive the hidden states for each of the impression events as well as the conversion event. In various embodiments, the number of attention layers may be equal to the number of impression events in a user journey. Each attention layer may receive the hidden state of its corresponding impression event and the hidden state of the conversion event in order incorporate the conversion event hidden state into the attribution prediction for each impression event. Trained attention weights 812 included in the attention layers 654 determine a attribution value for each of the impression events. The attribution value may be a representation of each impression events contribution to the conversion event. The attribution values may be fed into a softmax layer 804 to generate an normalized attribution probability that may be distributed over and event space in order to determine the prediction attribution event (i.e., the impression event that had the largest contribution to the conversion). In various embodiments, one or more third parties may complete a transaction (e.g., pay for a piece of targeted content and/or an ad placement at a specified location or domain) in response to the attribution probability exceeding a defined attribution threshold (e.g., an event having a 60% attribution probability or higher.

The training service 650 may use unsupervised and or supervised techniques to train the network layers 652 and attention layers 654. In various supervised training embodiments, the training service 650 may train each of the network and attention layers 654 on a set of training sequences using an optimization algorithm (e.g., gradient descent, stochastic gradient descent (SGD), and the like). The training sequences may encompass recent user data 634, for example, user data 634 that aggregates browsing data 624 including activities captured during the last 30 to 90 days. To reduce the amount of computational time required to generate the training sequences, the user data 634 required for training may be generated and stored frequently (e.g., daily, multiple times a day, and the like). At training time, the stored user data 634 may be aggregated into training sequences and the training service 650 may implement a sliding widow approach to training the machine learning models 660.

In various embodiments, the optimization algorithm may be combined with backpropagation through time to compute gradients needed during the optimization process, in order to change each weight of each network layer and/or each attention layer in proportion to the derivative of the error with respect to the corresponding weight. FIG. 8 illustrates an example training process for the attention layers 654 that incorporates back propagation. A loss function 802 determines the difference between the model prediction and an actual event. Matches between the prediction and an actual event are used to reenforce the model and differences between the predication and actual event are used to update model weights during back-propagation.

Various embodiments, that employ gradient descent include an error cut-off. Some examples employ stacks of recurrent neural networks and are trained by connectionist temporal classification to find a weight matrix that maximizes the probability of the sequence in the training set. In some examples, only parts of the recurrent neural network is trained, or only part of the network is supervised. Once trained, the learning module 800 may use probabilities of predictive paths to adjust bidding on inventory, place creative to guide down a more desirable journey path, or any other means.

In various embodiments, to train the network layers 652, the hidden states 710 may be fed into a softmax layer to obtain a distribution over an event space (e.g., a conversion event space). The distribution may include a probability of generating the conversion for each impression event. In various embodiments, the training data set used to train the network layers 652 may include multiple user journeys having conversions and known conversion attributions (i.e., labeled impression events that attributed to the conversions). For example, the impression event in the user journey that contributed to the conversion may be the event that occurred just before the conversion or may be identified by a user through a survey or other feedback mechanism. The impression event having the greatest attribution to the conversion may be labeled as the attribution event in each user journey included in the training dataset. To train the network layers 652, the predicted attribution event (i.e., the impression event having the greatest probability of attributing to the conversion) may be compared to the labeled attribution events. For example, a loss function may be used to perform the comparison by calculating an error value that increases each instance where the predicted impression event matches the actual impression event and decrease each instance where the predicted impression event is different from the actual impression event. The trained weights may then be adjusted through a back propagation function tests different values for the network weights to decrease the error value until the hidden states produced by the network layers 652 generate attribution event predictions having a minimum error value for a sample of user journeys.

The attention layers 654 may be trained in a similar fashion by feeding the hidden states from the trained network layers 652 into the attention layers 654. The predicted attribution event (i.e., the impression event having the greatest probability of attributing to the conversion) generated based on the attribution values determined by the attention layers 654 may be compared to the labeled attribution events. For example, the loss function 802 may be used to perform the comparison by calculating an error value that increases each instance where the predicted impression event matches the actual impression event and decrease each instance where the predicted impression event is different from the actual impression event. The attention weights may then be adjusted through a back propagation function tests different values for the attention weights 812 to decrease the error value until the attribution values produced by attention layers 654 generate attribution event predictions having a minimum error value for a sample of user journeys.

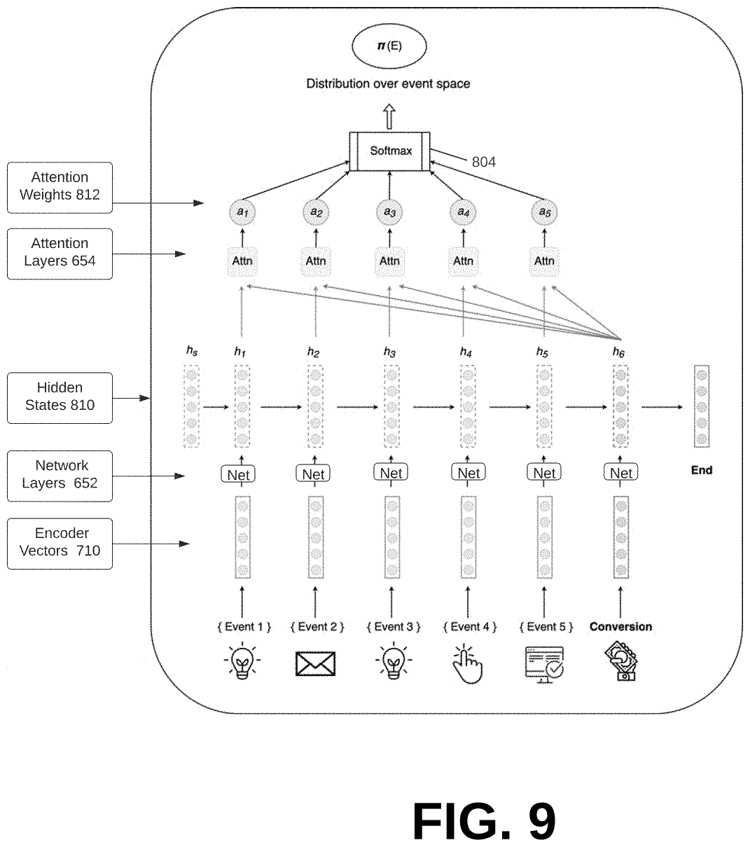

FIG. 9 illustrates an example architecture of a machine learning model used to determine conversion attribution for impression events in a user journey. The machine learning model 900 includes the encoder vectors 710, network layers 652, hidden states 810, attention layers 654, attention weights 812, and softmax layer 804 described above.

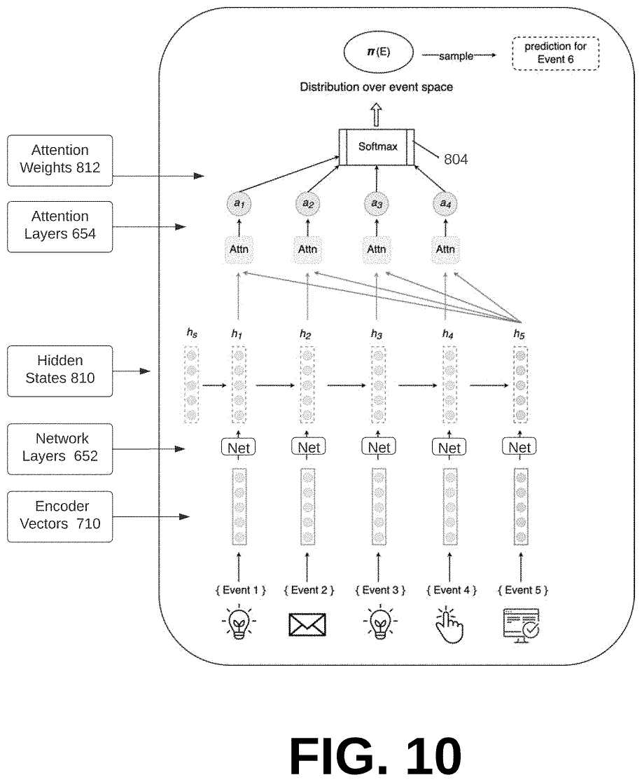

FIG. 10 illustrates an example architecture of a machine learning model used to predict a next event in a user journey. The machine learning model 1000 includes the encoder vectors 710, network layers 652, hidden states 810, attention layers 654, attention weights 812, and softmax layer 804 described above.

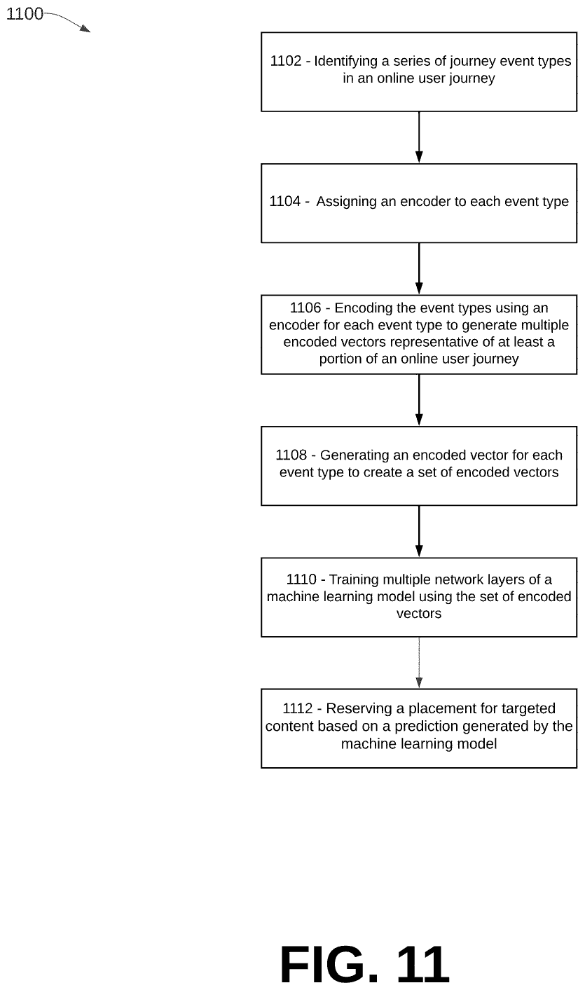

Some present examples also include methods. FIG. 11 is a block diagram of a process 1100 of reserving a placement of digital media at a specified location or domain based on one or more predictions generated by a machine learning model. At 1102, the system identifies a series of journey event types in an online user journey. At 1104, the system assigns an encoder to each event type. At 1106, the system encodes the event types using an encoder for each event type to generate multiple encoded vectors representative of at least a portion of an online user journey. At 1108, the system generates an encoded vector for each event type to create a set of encoded vectors. At 1110, the system trains multiple network layers of a machine learning model using the set of encoded vectors. At 1112, the system reserves a placement for targeted content based on a prediction generated by the machine learning model.

In this disclosure, the following definitions may apply in context. A “Client Device” or “Electronic Device” refers to any machine that interfaces to a communications network to obtain resources from one or more server systems or other client devices. A client device may be, but is not limited to, a mobile phone, desktop computer, laptop, portable digital assistant (PDA), smart phone, tablet, ultra-book, netbook, laptop, multi-processor system, microprocessor-based or programmable consumer electronic system, game console, set-top box, or any other communication device that a user may use to access a network.

“Communications Network” refers to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network, and coupling may be a Code Division Multiple Access (CDMA) connection, a Global System for Mobile communications (GSM) connection, or another type of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long-range protocols, or other data transfer technology.

“Component” (also referred to as a “module”) refers to a device, physical entity, or logic having boundaries defined by function or subroutine calls, branch points, application programming interfaces (APIs), or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components.

A “hardware component” is a tangible unit capable of performing certain operations and may be configured or arranged in a certain physical manner. In various example embodiments, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application-specific integrated circuit (ASIC). A hardware component may also include programmable logic or circuitry that is temporarily configured by software to perform certain operations. For example, a hardware component may include software executed by a general-purpose processor or other programmable processor. Once configured by such software, hardware components become specific machines (or specific components of a machine) uniquely tailored to perform the configured functions and are no longer general-purpose processors.

It will be appreciated that the decision to implement a hardware component mechanically, in dedicated and permanently configured circuitry, or in temporarily configured circuitry (e.g., configured by software) may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instant in time. For example, where a hardware component includes a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instant of time and to constitute a different hardware component at a different instant of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some example embodiments, the processors or processor-implemented components may be located in a single geographic location (e.g., within a home environment, an office environment, or a server farm). In other example embodiments, the processors or processor-implemented components may be distributed across a number of geographic locations.

“Machine-Readable Medium” in this context refers to a component, device, or other tangible medium able to store instructions and data temporarily or permanently and may include, but not be limited to, random-access memory (RAM), read-only memory (ROM), buffer memory, flash memory, optical media, magnetic media, cache memory, other types of storage (e.g., Erasable Programmable Read-Only Memory (EPROM)), and/or any suitable combination thereof. The term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions (e.g., code) for execution by a machine, such that the instructions, when executed by one or more processors of the machine, cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

“Processor” refers to any circuit or virtual circuit (a physical circuit emulated by logic executing on an actual processor) that manipulates data values according to control signals (e.g., “commands,” “op codes,” “machine code,” etc.) and which produces corresponding output signals that are applied to operate a machine. A processor may, for example, be a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), or any combination thereof. A processor may further be a multi-core processor having two or more independent processors (sometimes referred to as “cores”) that may execute instructions contemporaneously.

A portion of the disclosure of this patent document may contain material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

Although the subject matter has been described with reference to specific example embodiments, it will be evident that various modifications and changes may be made to these embodiments without departing from the broader spirit and scope of the disclosed subject matter. Accordingly, the specification and drawings are to be regarded in an illustrative rather than a restrictive sense. The accompanying drawings that form a part hereof show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Description, therefore, is not to be taken in a limiting sense, and the scope of various embodiments is defined only by any appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. An online user journey encoder:
one or more processors; and
a memory storing instructions that, when executed by at least one processor in the one or more processors, cause the at least one processor to perform at least the following operations:
identify a series of journey event types in an online user journey, the event types including an impression event, an email event, a click event, and a website visit;
assign an encoder to each event type;
encode each event type, using the assigned encoder, to generate an encoded vector for each event type, the encoded vector being representative of at least a portion of the online user journey relating to that event type;
aggregate the encoded vectors for each event type to create a set of encoded vectors, the set of encoded vectors including one or more of an impression event encoded vector, an email event encoded vector, a click event encoded vector, and a website visit encoded vector;
train multiple network layers of a machine learning model using the set of encoded vectors;
train an attention layer of the machine learning model using one or more hidden states generated by the network layers; and
generate prediction using the trained model;

2. The encoder of claim 1, wherein the prediction includes an occurrence probability for at least one further event in the online user journey; and
the processor is further configured to select a channel for distributing a piece of targeted content based on the occurrence probability.

3. The encoder of claim 1, wherein the prediction includes an attribution probability for at least one impression event; and
the processor is further configured to reserve a placement for targeted content at a specified location or domain based on the attribution probability.

4. The encoder of claim 1, wherein the processor is further configured to determine an attribution probability; and
complete a transaction based on the attribution probability exceeding a attribution threshold.

5. The encoder of claim 1, wherein the processor is further configured to:
generate a training dataset including known attribution events;
compare events having an attribution probability above an attribution threshold to known attribution events using a loss function; and
adjust the encoder weights of the network layers to minimize an error value generated by of the loss function.

6. The encoder of claim 1, wherein the processor is further configured to:
generate a training dataset including known attribution events;
compare events having an attribution probability above an attribution threshold to known attribution events using a loss function; and
adjust the attention weights of the attention layers to minimize an error value generated by of the loss function.

7. The encoder of claim 1, wherein the network layers are LSTM units.

8. The encoder of claim 1, wherein the attention layers include an attention unit for each impression event.

9. The encoder of claim 1, wherein each of the attention units receives the hidden state from its corresponding encoder and the hidden state of the conversion event.

10. A method of enhancing a real time bidding engine using a machine learning model including one or more attention layers, the method comprising:
identifying a series of journey event types in an online user journey, the event types including an impression event, an email event, a click event, and a web site visit;
assigning an encoder to each event type;
encoding each event type, using the assigned encoder, to generate an encoded vector for each event type, the encoded vector being representative of at least a portion of the online user journey relating to that event type;
aggregating the encoded vectors for each event type to create a set of encoded vectors, the set of encoded vectors including one or more of an impression event encoded vector, an email event encoded vector, a click event encoded vector, and a web site visit encoded vector;
training multiple network layers of a machine learning model using the set of encoded vectors;
training an attention layer of the machine learning model using one or more hidden states generated by the network layers; and
generating prediction using the trained model;

11. The method of claim 10, wherein the prediction includes an occurrence probability for at least one further event in the online user journey; and
the method further comprises select a channel for distributing a piece of targeted content based on the occurrence probability.

12. The method of claim 10, wherein the prediction includes an attribution probability for at least one impression event; and
the method further comprises reserving a placement for targeted content at a specified location or domain based on the attribution probability.

13. The method of claim 10, further comprising determining an attribution probability; and
completing a transaction based on the attribution probability exceeding a attribution threshold.

14. The method of claim 10, further comprising training the network layers by
generating a training dataset including known attribution events;
comparing events having an attribution probability above an attribution threshold to known attribution events using a loss function; and
adjusting the encoder weights of the network layers to minimize an error value generated by of the loss function.

15. The method of claim 10, further comprising training the attention layers by
generating a training dataset including known attribution events;
comparing events having an attribution probability above an attribution threshold to known attribution events using a loss function; and
adjusting the attention weights of the attention layers to minimize an error value generated by of the loss function.

16. The method of claim 10, wherein the network layers are LSTM units.

17. The method of claim 10, wherein the attention layers include an attention unit for each impression event.

18. The method of claim 10, wherein each of the attention units receives the hidden state from its corresponding encoder and the hidden state of the conversion event.
